(19) United States
(12) Patent Application Publication
(10) Pub. No.: US 2019/0337567 A1
(43) Pub. Date: Nov. 7, 2019

(54) ASSEMBLY OF A VEHICLE CRADLE ON A BODY INCLUDING A CASTING

(71) Applicant: RENAULT s.a.s., Boulogne-Billancourt (FR)

(72) Inventors: Maxime CHEVALIER, Voisins le Bretonneux (FR); Emmanuel JACQUES, Les Clayes sous Bois (FR)

(73) Assignee: RENAULT s.a.s., Boulogne -Billancourt (FR)

(21) Appl. No.: 16/462,096

(22) PCT Filed: Nov. 29, 2017
(86) PCT No.: PCT/EP2017/080754

§ 371 Date: May 17, 2019

(30) Foreign Application Priority Data
Dec. 6, 2016 (FR) 1661986

(51) Int. Cl. B62D 21/11; B60G 21/00; B62D 29/00

(52) U.S. Cl. CPC B62D 21/11; B62D 25/08; B62D 29/008; B60G 21/005

(57) ABSTRACT

A body structure includes at least one aluminum side rail, which allows the assembly of an aluminum cradle of a vehicle by an aluminum casting including an upper surface attached under the side rail, one or more lower portions attached to the cradle, and an opening allowing the passage of an drive shaft. The casting can also incorporate suspension interfaces.

The present invention relates to an assembly of a cradle on a vehicle body, in particular a motor vehicle, the assembly comprising a casting.

For reasons of lightening, the blank body of the vehicle is made of aluminum. The underbody of the body then comprises mostly a composition of aluminum profiles assembled by means of adhesion, riveting and/or welding, in particular for the parts which are subjected to high levels of mechanical and/or thermal stresses.

The objective is to obtain a solution for assembly of the cradle with the underbody, and in particular of the rear cradle with the rear side rails for a vehicle wherein the engine assembly is disposed at the rear. The suspension functions must also be able to be assembled in this area.

In general, vehicles are designed by assembling stamped steel parts. In fact, steel can easily be stamped, and makes it possible to obtain strong parts. The rear cradle and side rails thus constitute in a known manner a structure made of stamped parts. Similarly, the parts which fulfil the suspension functions are assembled on parts made of bent or stamped steel, added onto the structure.

Within the context of lightening of the structure, the use of extruded profiles limits the possibility of interfacing of the suspension elements. Aluminum casting then becomes an advantageous process.

Document FR2890641A1 discloses lateral parts of underframes which are made by molding of aluminum under pressure, and welded to a central part of the underframe produced in the form of an extruded aluminum profile. Molding under pressure is more suitable for production of thin parts than bulky parts. The thinness has the disadvantage of detracting from the strength, which disadvantage the prior document proposes to eliminate by providing reinforcement ribs. The mounting of an engine assembly on the underframe disclosed poses numerous problems, such as, for example, but not only, the support and passage of the drive shaft towards the wheels.

In order to eliminate the problems of the prior art, the subject of the invention is an assembly of an aluminum cradle on a vehicle body structure comprising at least one lateral side rail made of aluminum, characterized in that it comprises an aluminum casting comprising an upper face secured below the lateral side rail, one or a plurality of lower parts secured on the cradle, and an opening which permits passage of the drive shaft.

Advantageously, the casting is obtained by gravity die casting.

In particular, the casting is constituted by an aluminum alloy comprising 6.5 to 7.5% silicon and 0.25 to 0.45% manganese providing resistance to traction of between 285 and 295 MPa.

In particular also, the opening is in the form of a semi-cylindrical concave depression provided in an upper face of the casting.

Again in particular, the upper face of the aluminum casting is secured below the lateral side rail by means of screws, and/or the lower part(s) of the aluminum casting is/are secured on the cradle by means of screws.

Preferably, the aluminum casting comprises a first pair of fins on a lateral wall in order to mount an end of an arm or of a first branch of a suspension triangle.

More particularly, the aluminum casting comprises a second pair of fins on the same lateral wall in order to mount an end of a clamp rocker bar.

More particularly also, the aluminum casting comprises on said lateral wall an interface for securing of a clevis in order to mount an end of a second branch of a suspension triangle.

In particular, said clevis is made of steel.

Advantageously also, the aluminum casting comprises a flattened part on which a stabilizing bar bearing is secured.

In particular, the bearing is made of polymer material.

Also advantageously, the assembly comprises a stirrup which is integral with a transverse beam of the cradle, and on which there is secured a reinforcement tie rod for a torque absorption rocker bar.

Preferably, the body structure comprises a right lateral side rail and a left lateral side rail which are welded on each end of a central cross-member.

In particular, the right lateral side rail, the left lateral side rail and the central cross-member are hot-extruded aluminum profiles.

Other characteristics and advantages of the invention will be understood better from reading the description of an embodiment which is in no way limiting, and is illustrated in the appended drawings, in which:

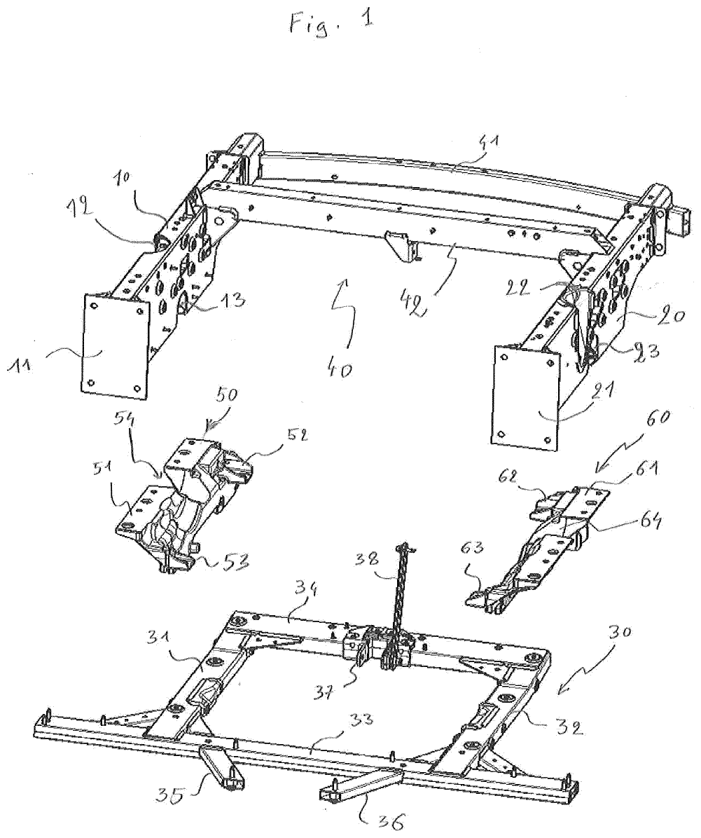

FIG. 1 is an exploded schematic view in perspective of an assembly of a cradle on a body according to the invention;

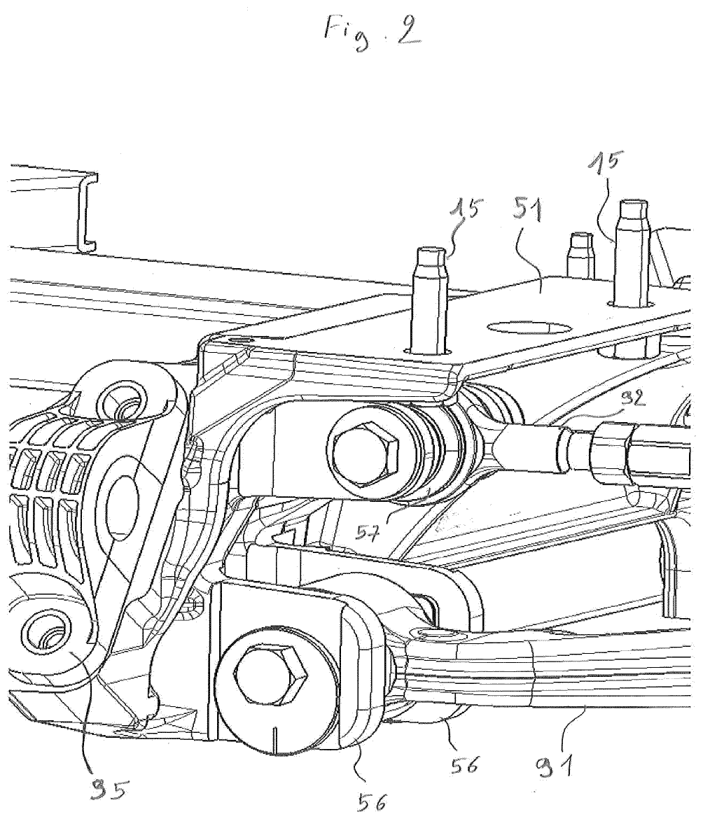

FIG. 2 is a schematic view in perspective of a detail of a casting illustrating the main suspension functions combined with the assembly functions in FIG. 1;

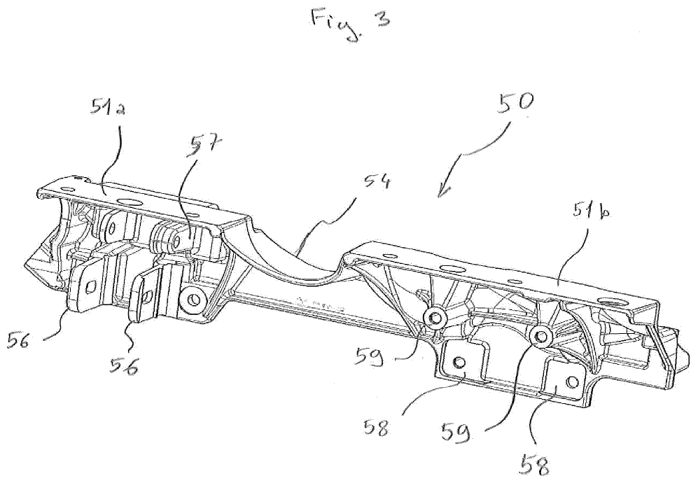

FIG. 3 is a schematic view in perspective of an outer face of the casting designed for mounting of suspension elements;

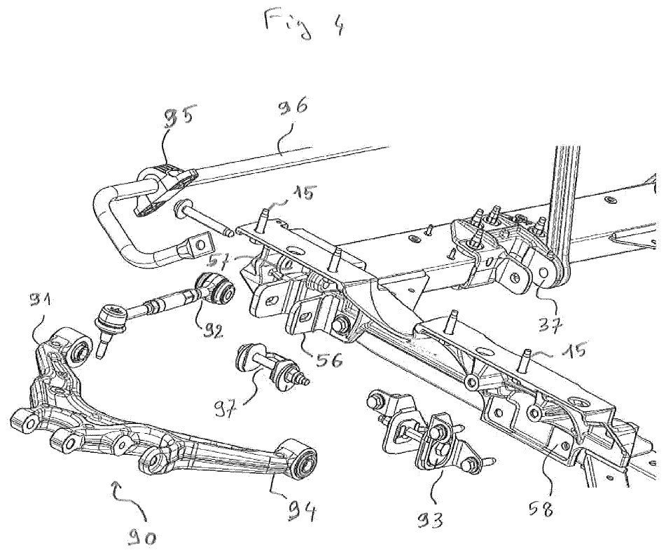

FIG. 4 is an exploded schematic view in perspective of the suspension elements associated with the casting secured on the cradle;

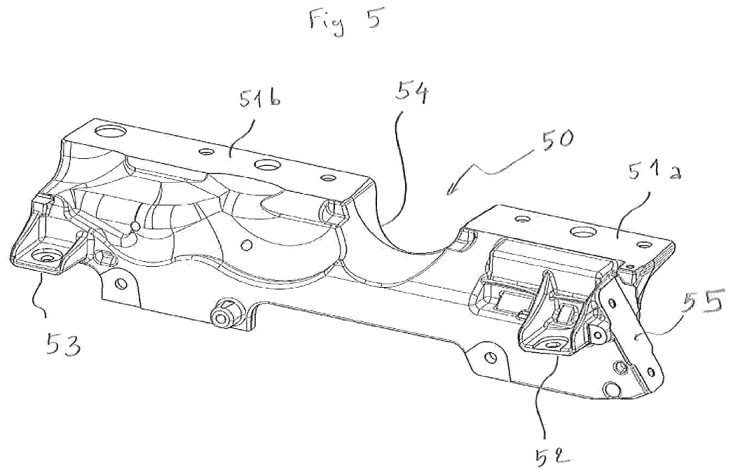

FIG. 5 is a schematic view in perspective of an inner face of the casting designed to be secured on the cradle.

The assembly according to the invention makes it possible to obtain compact, light, strong parts on which the suspension elements can easily be fitted.

The design according to the invention is based on the choice of producing an aluminum casting which permits the connection between the side rails of the vehicle body structure and the cradle, whilst providing the fastenings necessary for the suspension elements. Thus, the anti-camber bar, the lower suspension triangle and clamp rocker bar can be secured firmly, and with adequate interfaces, on the casting. The foundry process associated with a machining operation provides significant latitude in the forms which are permitted and their precision. In addition, the use of the casting makes it possible to integrate all of the functions in a minimum amount of space, thus complying with vehicle architecture constraints.

In the embodiment described hereinafter by way of illustration on a vehicle with rear-wheel drive, it will be understood how the casting also provides the vehicle structure with rigidity, and in particular at the rear side rails, which are to a large extent instituted so as to permit the passage of the drive shaft.

A description is now provided of how the casting fulfils three essential functions, comprising those of assembling the rear cradle on the side rails, providing the interfaces of the suspension elements, and strengthening the structure.

FIG. 1 shows an aluminum cradle assembly 30 for a vehicle on a body structure comprising a right lateral side rail 10 and a lateral side rail 20, both made of aluminum. The structural part of the body 40 which is described in particular here for a vehicle with rear-wheel drive constitutes a rear part of the body structure. A person skilled in the art will easily be able to transpose the teaching of the invention, whilst reading the remainder of the description, to a front-wheel drive vehicle if they feel this is necessary.

In the embodiment disclosed, each of the rear side rails 10, 20 comprises a respective front face 11, 21 to be secured on a central body part constituting the passenger space of the vehicle, which passenger space itself is preferably made of aluminum which is extruded, stamped, or bent, and assembled by means of adhesion-riveting. For their part, the side rails 10, 20 are preferably made of hot-extruded aluminum.

The outer lateral face of each side rail 10, 20, in other words each side rail face which is oriented towards an outer side of the vehicle, comprises a conical concave depression 12, 22, with a point which is oriented downwards, which depression is open both on the deepest side (base of the cone) on the upper face, and on the side of the axis of the cone on the outer lateral face of the side rail, in order to permit passage of a shock absorber (not represented).

The side rails 10, 20, which have dimensions so as to support an engine assembly, are connected at their upper part by a central cross-member 42, and at their rear end by a rear end cross-member 41, both made of aluminum which is extruded, welded and/or screwed on. The right lateral side rail 10, the left lateral side rail 20, and the central cross-member 42 are for example straight, hot-extruded aluminum profiles. The rear end cross-member 41 is for example an aluminum profile which is extruded, then hot-curved.

Preferably, the right lateral side rail 10 and the left lateral side rail 20 are welded at each end of the central cross-member 42, and the rear end cross-member 41 is secured by being screwed on the rear ends of the side rails 10, 20.

An aluminum casting 50 comprises an upper face 51, which is secured below the side rail 10. Preferably, the upper face 51 comprises a rear part 51a which is secured at a rear position relative to the point of the half-cone of the concave depression 12, and a front part 51b which is secured at a front position relative to the point of the half-cone of the concave depression 12. Thus, the aluminum casting 50 makes it possible to reinforce the side rail 10 below the location of the point of the half-cone formed by the concave depression 12. Symmetrically, an aluminum casting 60 comprises an upper face 61 which is secured below the side rail 20 in a manner which is symmetrical compared with the aluminum casting 50, in order to reinforce the side rail 20 below the location of the point of the half-cone formed by the concave depression 22.

More particularly, in this case, the cradle 30 is a rear cradle which comprises a right lateral beam 31 and a left lateral beam 32, which are connected by a rear transverse beam 34 and by a front transverse beam 33. The beams 31 to 34 can be made of aluminum which is stamped and bent. An embodiment of the beams 31 to 34 in the form of aluminum profiles, for example obtained by hot extrusion, provides better mechanical and thermal resistance. The front transverse beam 33 projects from each side of the cradle in order to be secured better on the central unit of the vehicle. The rear transverse beam 34 supports a stirrup 37 with which it is rendered integral, for example by means of a screwed connection, and on which a reinforcement tie rod 38 is secured for an engine torque absorption rocker bar (not represented).

An oblique beam 35 which is oriented from the beam 31 towards the interior of the passenger space, passing through the beam 33, and an oblique beam 36 which is oriented from the beam 32 towards the interior of the passenger space, passing through the beam 33, make it possible to diffuse the forces by absorption on the tunnel (not represented) for the passage of cables and ducts from the front of the passenger space to the engine compartment which is situated at the rear of the vehicle.

At least a lower part of the casting 50 and of the casting 60 is secured on the cradle 30. “Lower part” means any possible part of the casting which is situated below the upper face 51. In the embodiment illustrated in FIG. 5, the aluminum casting 50 comprises in its lower part a protrusion 52 which is situated at the rear of an inner lateral face, and a protrusion 53 which is situated at the front of the inner lateral face. “Inner lateral face” means any face of the casting which is oriented towards, in other words facing towards, the interior of the engine compartment. The protrusions 52, 53 can be on lower parts of different levels. Each protrusion 52, 53 comprises a surface which is substantially, but not necessarily strictly, parallel to the upper face 51 of the aluminum casting 50, and is pierced substantially in its center in order to permit the passage of a screw for securing the lateral beam 31 on the upper face. Similarly, the aluminum casting 60 comprises on its lower part a protrusion 62 which is situated at the rear of an inner lateral face, and a protrusion 63 which is situated at the front of the inner lateral face, as can also be seen in FIG. 1.

The casting 50 comprises a through-opening 54 from the inner lateral face to the outer lateral face, in order to permit passage of the drive shaft of the engine assembly towards the right wheel (not represented). Thus, the casting 50 prevents the side rail 10 from becoming fragile as a result of passage of the drive shaft passing through it. The opening 54 can be produced in tubular form, but this embodiment requires a casting which is high enough to contain the diameter of the tubular form necessary for the passage of the drive shaft.

In order to reduce the size of the casting 50, the opening 54 is in the form of a semi-cylindrical concave depression provided in the upper face 51 of the casting 50. The lower face of the side rail 10 then comprises a semi-cylindrical concave depression 13, which is designed to form a cylindrical hollow with a diameter sufficient for the passage of the drive shaft, when the semi-cylindrical concave depression 13 is disposed above and facing the opening 54 in the form of a semi-cylindrical concave depression. The rear part 51a of the upper face 51 is then secured in a rear position relative to the semi-cylindrical concave depression constituting the opening 54, and the front part 51b is then secured in a front position relative to the semi-cylindrical concave depression constituting the opening 54. Thus, the casting 50 reinforces with a minimal size the location of the side rail 10 in which a sufficient opening by means of concave depression can be provided, in combination with that of the casting for the passage of the drive shaft, and also, in its near vicinity the opening 12 can be provided, it too by concave depression, sufficient for the passage of the shock absorber (not represented) as close as possible to the side rail 10.

Similarly, the casting 60 comprises a through opening 64 from the inner lateral face to the outer lateral face, in order to permit passage of the drive shaft of the engine assembly towards the left wheel (not represented).

It is possible to obtain each aluminum casting by molding under pressure, by taking the well-known measures necessary to avoid the phenomena of shrinkage when cooling and micro-bubbles, for example by means of use of a sink head. In order to obtain more easily the mechanical characteristics required, each casting 50, 60 is obtained by gravity casting of aluminum. Advantageously in comparison with sand molding, gravity die casting permits use and re-use of a permanent mold.

The gravity die casting process makes it possible to obtain particularly remarkable mechanical characteristics of each casting 50, 60, by use of an appropriate aluminum alloy, in particular an aluminum alloy comprising 6.5 to 7.5% silicon and 0.25 to 0.45% manganese, which provides resistance to traction of between 285 and 295 MPa.

The upper face 51 and 61 respectively of the aluminum casting 50 and 60 respectively is secured below the side rail 10 and 20 respectively by means of screws 15. In a comparable manner, the lower part(s) 52, 53 and 62, 63 respectively of the aluminum casting 50 and 60 respectively are secured on the upper face of the beam 31 and 32 respectively of the cradle 30 by screws. Steel screws are preferably used for the mechanical characteristics of this metal which are particularly appropriate for the securing, said screws being previously subjected to a zinc-nickel treatment because of its characteristics of making the steel compatible in contact with the aluminum.

As illustrated by FIG. 3, the aluminum casting 50, and likewise symmetrically the aluminum casting 60, comprises a first pair of fins 56 on a lateral wall, in order to mount an end of an arm or of a first branch 91 of a suspension triangle. In particular, the pair of fins 56 extends perpendicularly to the outer lateral face of the aluminum casting 50, below the rear part 51a of the upper face 51. Each fin is pierced substantially in its center by an opening which permits passage of a shaft or screw 97 for retention of the arm or of the first branch 91 of a suspension triangle 90.

The aluminum casting 50, and likewise symmetrically the aluminum casting 60, comprises a second pair of fins 57 on said lateral wall, in order to mount an end of a clamp rocker bar 92.

The aluminum casting 50, and likewise symmetrically the aluminum casting 60, also comprises on the lateral wall an interface 58, 59 for securing of a clevis 93. As illustrated by FIG. 4, the clevis 93 comprises two vertical walls for mounting of an end of a second branch 94 of a suspension triangle. Making the clevis 93 of steel makes it possible to bend an upper part oriented towards the exterior and a lower part oriented towards the interior of each vertical wall, without loss of mechanical quality, in order to be applied respectively against two protrusions 59 and against two vertical flattened parts 58 of the interface in order to be secured on them by means of screws.

In addition, the aluminum casting 50, and likewise symmetrically the aluminum casting 60, comprises an oblique flattened part 55 on which a bearing 95 of a stabilizing bar 96 is secured. Making the bearing 95 of polymer material contributes towards the lightening of the assembly.

The casting thus makes it possible to incorporate interfaces for the vehicle suspension, in addition to its function of a connection between the cradle and the body structure.

1-15. (canceled)

16. An assembly of a vehicle aluminum cradle on a body structure, comprising:
at least one lateral side rail made of aluminum; and
an aluminum casting comprising an upper face secured below said side rail, one or a plurality of lower parts secured on said cradle, and an opening which permits passage of the drive shaft.

17. The assembly as claimed in claim 16, wherein said casting is obtained by gravity die casting.

18. The assembly as claimed in claim 16, wherein said casting is constituted by an aluminum alloy comprising 6.5 to 7.5% silicon and 0.25 to 0.45% manganese providing resistance to traction of between 285 and 295 MPa.

19. The assembly as claimed in claim 16, wherein said opening is in the form of a semi-cylindrical concave depression provided in said upper face.

20. The assembly as claimed in claim 16, wherein said upper face of the aluminum casting is secured below said side rail by screws.

21. The assembly as claimed in claim 16, wherein the lower part(s) of said aluminum casting is/are secured on said cradle by screws.

22. The assembly as claimed in claim 16, wherein the aluminum casting comprises a first pair of fins on a lateral wall in order to mount an end of an arm or of a first branch of a suspension triangle.

23. The assembly as claimed in claim 22, wherein the aluminum casting comprises a second pair of fins on said lateral wall in order to mount an end of a clamp rocker bar.

24. The assembly as claimed in claim 22, wherein the aluminum casting comprises on said lateral wall an interface to secure a clevis in order to mount an end of a second branch of a suspension triangle.

25. The assembly as claimed in claim 24, wherein said clevis is made of steel.

26. The assembly as claimed in claim 16, wherein said aluminum casting comprises a flattened part on which a stabilizing bar bearing is secured.

27. The assembly as claimed in claim 26, wherein said bearing is made of polymer material.

28. The assembly as claimed in claim 16, further comprising a stirrup which is integral with a transverse beam of the cradle, and on which there is secured a reinforcement tie rod for a torque absorption rocker bar.

29. The assembly as claimed in claim 16, wherein the body structure comprises a right lateral side rail and a left lateral side rail which are welded on each end of a central cross-member.

30. The assembly as claimed claim 29, wherein the right lateral side rail, the left lateral side rail, and the central cross-member are hot-extruded aluminum profiles.
